(19) United States
(12) Patent Application Publication
(10) Pub. No.: US 2022/0348826 A1
(43) Pub. Date: Nov. 3, 2022

(54) Composition for Wetting of Hydrophobic Soils

(71) Applicant: Ethox Chemicals, LLC, Greenville, SC (US)

(72) Inventors: Charles F. Palmer, JR., Greenville, SC (US); William C. Floyd, III, Greenville, SC (US); Lester A. Haney, II, Greenville, SC (US); Andrew K. Tobias, JR., Greenville, SC (US); Elizabeth H. Lowe, Greenville, SC (US)

(21) Appl. No.: 17/726,689

(22) Filed: Apr. 22, 2022

Related U.S. Application Data
(60) Provisional application No. 63/178,030, filed on Apr. 22, 2021.

(51) Int. Cl. C09K 17/28; C09K 17/24

(52) U.S. Cl. CPC C09K 17/28; C09K 17/24

(57) ABSTRACT

A mixture for treating a hydrophobic surface and a method for treating hydrophobic surfaces is provided. The mixture comprises:
a wetting agent comprising;
a compound of Formula I:

R¹((CH₂CH₂O)ₙR²)ₓ Formula I
wherein:
R¹ is a core group derived from a linear, cyclic or branched polyol with 1-55 carbons or a linear, cyclic or branched polyamine with 1-22 carbons wherein hydrogens on the alcohol group or hydrogens on the amine group are replaced with (CH₂CH₂O)ₙ or R¹ is defined by —R⁶(—C(═O)O—)ₘ;
R² is a hydrophobic group preferably selected from the group consisting of R³, the elements necessary to form an ester, specifically —COR⁴, or the elements necessary to form a urethane, specifically —CONHR⁵;
R³-R⁵ are each independently an alkyl of 6-22 carbons, wherein the alkyl is a linear, cyclic or branched and preferably linear;
n, on average is 4-100;
x is 2-20;
R⁶ represents a bond or a linear, cyclic or branched alkyl with 6-22 carbons; and
m is 2-20.

### CROSS-REFERENCE TO RELATED APPLICATIONS

This application claims the priority of pending U.S. Provisional Application No. 63/178,030 filed Apr. 22, 2021 which is incorporated herein by reference.

### FIELD OF THE INVENTION

The present invention is related to improvements in wetting of soils, particularly hydrophobic soils. More specifically, the present invention is related to a composition which is particularly suitable for use in wetting soils and particularly for wetting hydrophobic soils utilizing a capped poly(ethylene glycol) (PEG) wherein the PEG is capped with hydrophobic groups.

### BACKGROUND

The present invention is related to novel combinations of nonionic surfactants having desirable properties for improving the water transport characteristics of hydrophobic surfaces. This invention is generally related to the treatment of hydrophobic surfaces, hydrophobic substrates, and more specifically the treatment of hydrophobic soils. The instant invention is directed to a new method for improving the water transport characteristics of hydrophobic surfaces and hydrophobic soils.

It is known that soil particles contain a large number of small channels or capillaries through which water is capable of flowing, and flow may be graded on the basis of the capillary or pore diameters. As water is made to flow through a channel, whether that channel be a soil pore or not, the rate of capillary water flow through the channel will be higher if the water is capable of wetting the channel surface. At the interface of the water and the capillary surface, however, there exists a long range van der Waals interaction between the water and the capillary surface. While the van der Waals interaction typically extends less than 200 angstroms into the body of water, it nonetheless decreases the ability of the water to wet the capillary surface, thereby increasing the contact angle between the water and the capillary surface and hindering the flow of water therethrough. While the negative effect of the van der Waals interaction may be negligible in the case of water flowing through a household pipe, when one considers the flow of water through minute soil pores, this interaction has a major effect.

Agronomists and farmers have to work with all types of plant growth media such as sand, natural earth, horticultural soils, and various soil-mimicking, soil-less plant culture substrates; however, the bane of essentially all agriculturalists is a hydrophobic/water repellent soil. Water repellent soil retards water infiltration into the soil matrix and often renders entire areas of the upper layers of the soil substrate essentially impervious to water penetration. Under rainfall or irrigation conditions, dire environmental consequences can result from the water repellency of the topsoil such as surface runoff of water and aqueous compositions containing treatment materials, such as pesticides and fertilizers, into pristine areas and/or potable reservoirs. There are serious consequences resulting from aqueous pesticide flow through “fingers” that usually attend water repellent soil which can provide rapid transport of pesticide compositions to the local ground water table and thus increase the risk of ground water contamination.

The hydrophobicity/water repellency of a soil is not only a function of the initial water content of the soil but is also a function of soil particle size and the type of organic matter incorporated therein. For example, sands are more prone to water repellency than clays. Organic matter induces water repellency in the soils in many ways, such as by providing hydrophobic organic substances leached from the plant litter; organic substances that have been irreversibly dried; and microbial by-products.

Before water will evenly infiltrate into or percolate through a soil matrix, there must be a continuous film of water on the soil particles. In other words, the soil must first be wetted before water will flow. In addition, getting the soil evenly wetted is of paramount importance to the healthy growth of plants or seeds which are to be grown in the soil. Thus, agriculturalists will often apply various wetting agent surfactant compositions directly to the soil.

Although an increasing number of researchers are aware of the occurrence and consequences of water repellency in a wide range of soils, it is still a neglected field in soil science. (Dekker et al., International Turfgrass Society Research Journal, Volume 9, 2001, pages 498-505)

It has been recognized for years that in water repellent soil significant spatial variability can occur both in soil water content and degree of water repellency. Agriculturalists have attacked the soil water repellency problem through the use of wetting agent surfactant compositions. The degree of efficacy among chemistries and formulations has varied significantly. Often, the amount of surfactant required to ameliorate water repellency and/or to enhance infiltration, either perform variably or in an attempt to improve performance, higher rates of wetting agents are applied, such elevated rates often becoming injurious to plants.

Hydrophobic soils can cause problems on golf courses and other turf areas, in nurseries and greenhouses, and in open fields. Golf course managers commonly report problems with localized dry spots on their greens. These dry spots become a serious turf management problem during the summer months, especially during periods of drought. Despite frequent irrigation, the soil in these spots resists wetting, resulting in patches of dead or severely wilted turf. The water applied wets the turf but does not adequately penetrate the soil surface to reach the root zone.

Nursery operators sometimes encounter hard-to-wet media in pots and greenhouse beds. Farmers who work organic soils often complain that the soil wets too slowly, reducing crop productivity. Problems with hydrophobic soils are also commonly associated with citrus production areas, with locations where mine spoils have been deposited, and with burned-over forestland and grassland.

If water cannot readily penetrate and wet the soil, the availability of moisture to plants is reduced, decreasing the germination rate of seeds, the emergence of seedlings, and the survival and productivity of crop plants. Lack of sufficient water in the soil also reduces the availability of essential nutrients to plants, further limiting growth and productivity. In addition, water that cannot penetrate the soil runs off the surface and increases soil erosion. Water repellency often occurs in localized areas. As a result, the soil wets non-uniformly, and dry spots occur.

In hydrophobic soils, the soil particles are apparently coated with substances that repel water, much like wax. In studies of localized dry spots in turf grass, the soil particles were found to be coated with a complex organic, acidic material. Humic acid is often a component of this acidic material.

Nonionic surfactants, or surface active wetting agents, reduce the surface tension of water allowing the water molecules to spread out. When applied to water repellent soils in high concentrations, surfactants can improve the ability of water from rain or watering to penetrate the soil surface and thus increase the infiltration rate. However, most nonionic surfactants have significant water solubility and thus are rapidly removed by repeated rains or watering. In addition, most nonionic surfactants have one or more hydroxyl end groups that are easily oxidized or attacked by microbial agents, both of which reduce the durability of the treatment.

The prevention of dew formation on grass blades on managed grass and turf surfaces is also often desirable. The water drops present in dew provide needed moisture for the growth of fungal diseases of turf grasses. If the formation of dew is suppressed, the grass blades can dry out more quickly and thus the growth of fungal diseases can be minimized.

In dry periods, turf can be affected by drought stress. This can manifest itself in a number of ways, and in extreme cases the turf may die. Turf grass maintained on light soil, e.g. sand root zone golf greens and links golf courses, is particularly prone to drought stress as is turf which is grown in generally poor soil conditions. Curiously, drought stress not only occurs in dry conditions, but also in relatively wet seasons due, for example, to rootbreaks, buried materials close to the surface, or through general inefficiency of an irrigation system.

Soils can also suffer drought stress. Thus, on heavy soils, one of the first signs of drought stress is that surface cracks appear on the soil. It will be appreciated that drought stress, in all its various forms, is undesirable and that it would be advantageous to avoid or reduce it.

So-called soil capping, i.e. crusting of the soil surface, can occur due to the pounding action of raindrops on soil. Capping can give rise to various problems, especially in seedbeds on light soils where it can prevent or reduce seedling emergence, thus resulting in a patchy, uneven sward. It would be desirable to be able to avoid soil capping, or at least reduce its effects.

Additionally, in many places water is becoming an ever decreasing resource, as is evidenced by dry rivers, low water tables and frequent restrictions on water usage. Further, in times of water shortage, it is often amenity users of water (e.g. golf courses etc.) where restrictions are enforced. It would, therefore be highly advantageous to be able to treat turf and soil so as generally to improve their water conservation so as to promote efficient use and minimize wastage.

It is also known that water conservation is a major issue in the United States and other countries, as water becomes an increasingly expensive commodity. Turf, particularly managed turf such as that located at golf courses, athletic fields, office parks and similar areas, uses large amounts of water. In past surveys by the Golf Course Superintendents Association of America (GCSAA), respondents indicated that irrigating an eighteen hole golf course in the U.S., having an average area of 77.7 irrigated acres, required an average of 28.5 million gallons of water each year. Of course the survey indicated regional differences in irrigation demand, with the Southwest US requiring 88 million gallons of water per year while the Mid-Atlantic States required 10 million gallons of water on average.

Among other problems faced in the areas of managed turf is localized dry spot caused by water-repellent soil conditions. Although this hydrophobic soil condition has several possible causes, researchers generally agree that the formation of an organic coating on the soil particles caused by the decomposition of plants and/or organisms causes the problem. The condition is characterized by irregular and isolated areas of problematic turf grass on the golf course, in the lawn or in other areas of turf.

The symptoms of localized dry spot are treated with surfactants, or surface-active agents. Some surfactants used to treat the condition are surfactant polymers. A surfactant polymer generally contains large segments or “blocks” of monomer which are hydrophobic in nature, attached to large blocks, which are hydrophilic in nature. Such surfactant polymers are generally referred to as “block copolymers” and give the polymer its surface-active nature. It is generally accepted that the hydrophobic portion of the surfactant molecule is attracted to the water repellent organic coating on the soil, whereas the hydrophilic portion of the surfactant remains readily accessible to water, thus allowing water to move into the soil profile, rather than running off of the surface.

A large number of surfactants are currently being marketed to manage localized dry spots. Such products are often marketed as soil wetters or wetting agents. Wetting agents are materials that increase the area that a droplet of a given volume of spray mixture will cover on a target. The management approach for using soil wetters and wetting agents generally involves direct application of the agents to the localized, problematic area, on an as needed basis, as part of an overall caring program.

By far the most common commercially available soil wetting agents are copolymers of ethylene oxide (EO) and propylene oxide (PO). These may be either block copolymers or random copolymers of EO and PO in various ratios. These include EO/PO block copolymer products such as L-62, L-64, and 25-R-2, as well as some EO/PO copolymers with C1-C4 end groups or ester groups.

There a number of reasons that many EO/PO block copolymers are used as soil wetting agents. One is that they can be readily emulsified into water for delivery to turf via aqueous spray application. Secondly, the PO groups or blocks are hydrophobic and act to adhere the copolymer onto the hydrophobic soil particles. Once coated onto the soil particle, the EO blocks attract water and promote water wicking along the surface. This results in the hydrophobic, water repellent soil particles becoming water wicking, readily moving water across their surfaces. This promotes rainwater or irrigation water penetrating through the soil to reach the root zone to nourish the turf grass. This water wicking effect lasts until the polymer washes off the soil particles or is degraded by soil microbes.

U.S. Pat. Nos. 6,857,225 and 6,948,276, each of which is incorporated herein by reference, describe a soil additive formulation for reducing water repellency comprising a multi-branched wetting agent having an “oxygen-containing polyfunctional base compound and at least three surfactant branches attached thereto, wherein each surfactant branch includes both hydrophilic and hydrophobic constituents.” The formulation also includes a secondary compound that actively lowers the surface tension of humic acid waxy coatings from hydrophobic sand particles. U.S. Pat. No. 6,857,225 describes a method for reducing localized dry spot formation by application of the additive formulation.

U.S. Pat. No. 9,487,698 B2 is directed to fatty acid ester-capped random and block copolymer wetting agents for treating sandy soils for long-term reduction of water repellency. Importantly, such capped wetting agents provide sustained moisture penetration over a sustained period of time since they have very low water solubility and thus are not easily rinsed off the treated surfaces. In addition, microbial decomposition is slowed due to the caps. Methods of treating sandy soils with such compounds and formulations thereof are also contemplated within this invention.

There has been a long-felt need for soil treatment compositions that contain a long lasting soil particle treatment to allow increased wetting rates so that rain or irrigation water is able to quickly penetrate and infiltrate the water repellent soil. The use of these wetting agent compositions will result in a more effective wetting of the root zone during rain events and/or irrigation applications as well as improve the ability of the soil to hold water in the root zone, thereby inducing better plant growth and decreased water run-off. There is also an ongoing need for hydrophilic treatments for soils that are durable to repeated exposures to water and resist rapid oxidation and microbial attack. The treatment agent must also not harm plant life exposed to it. Propylene oxide and ethylene oxide are derived from petroleum and thus are not biorenewable. These two materials are occasionally subject to supply shortages which limit their availability and usefulness.

In spite of the extensive efforts focused on improved soil wetting the art still lacks a suitable solution. More specifically, the art lacks a composition capable of improving the water retention capabilities of soil while also mitigating the effects of humic acid in and on the soil.

### SUMMARY OF THE INVENTION

It is a primary object of the present invention to provide non-ionic surfactants or combinations of non-ionic surfactants useful for treating hydrophobic soils.

It is another object of the present invention to provide a method of promoting the transport of water through medium and coarse-grained soils by the use of economical quantities of a soil amendment.

It is a further object of the present invention to provide such a process where the soil amendment is also a composition characterized by a low washout rate from soil, thereby rendering the composition even more cost-effective.

It is also an object of the present invention to provide a method for improving the water transport characteristics of hydrophobic soils.

A further object of the invention is to provide capped PEG's to enhance the infiltration of water and/or aqueous compositions through hydrophobic/water repellent soil.

It is a specific object of the present invention to provide certain hydrophobic, water insoluble polymers or blends thereof, to hydrophobic soil or turf to improve the ability of water to penetrate the soil surface and infiltrate the treated layers of soil.

It is an object of this invention to provide compositions that enhance the infiltration of water and/or aqueous compositions through hydrophobic/water repellent soil and that contain more biorenewable content and that are readily biodegradable.

A still further object of the invention is to provide a method of treating turf and soil to alleviate drought stress and soil cupping and to improve water conservation in soil.

A particular advantage of the invention is the ability to provide soil wetting technology which does not utilize propylene oxide.

The exclusive use of ethylene oxide reduces the use of petroleum based propylene oxide and improves the amount of renewable carbon content.

These and other advantages, as will be realized, are provided in a mixture for treating a hydrophobic surface comprising: a wetting agent comprising; a compound of Formula I:

R¹((CH₂CH₂O)ₙR²)ₓ Formula I

wherein:
R¹ is a core group derived from a linear, cyclic or branched polyol with 1-55 carbons or a linear, cyclic or branched polyamine with 1-22 carbons wherein hydrogens on the alcohol group or hydrogens on the amine group are replaced with (CH₂CH₂O)ₙ or R¹ is defined by —R⁶(—C(═O)O—)ₘ;
R² is a hydrophobic group preferably selected from the group consisting of R³, the elements necessary to form an ester, specifically —COR⁴, or the elements necessary to form a urethane, specifically —CONHR⁵;
R³-R⁵ are each independently an alkyl of 6-22 carbons, wherein the alkyl is a linear, cyclic or branched and preferably linear;
n, on average is 4-100;
x is 2-20;
R⁶ represents a bond or a linear, cyclic or branched alkyl with 6-22 carbons; and
m is 2-20.

Another embodiment is provided in

a method for treating a hydrophobic surface comprising:
forming a wetting agent comprising;
a compound of Formula I:

R¹((CH₂CH₂O)ₙR²)ₓ Formula I

wherein:
R¹ is a core group derived from a linear, cyclic or branched polyol with 1-20 carbons or a linear, cyclic or branched polyamine with 1-20 carbons wherein hydrogens on the alcohol group or hydrogens on the amine group are replaced with (CH₂CH₂O)ₙ or R¹ is defined by —R⁶(—C(═O)O—)ₘ;
R² is a hydrophobic group preferable selected from the group consisting of R³, the elements necessary to form an ester, specifically —COR⁴, or the elements necessary to form a urethane, specifically —CONHR⁵;
R³-R⁵ are each independently an alkyl of 6-22 carbons, wherein the alkyl is a linear, cyclic or branched and preferably linear;
n, on average is 4-100;
x is 2-20;
R⁶ represents a bond or a linear, cyclic or branched alkyl with 6-22 carbons; and
m is 2-20;
and applying the wetting agent to the hydrophobic surface.

### DESCRIPTION

The present invention is also related to a mixture for, and method of, enhancing water retention of soils and providing plant nutrients thereto over an extended period of time using capped PEG's. Furthermore, the present invention is generally related to the use of capped PEG's to enhance the infiltration of water and/or aqueous compositions through hydrophobic/water repellent soil. More particularly, the present invention is related to the use of capped PEG's to rapidly improve the hydrophilicity of such soil.

The invention is further related to a new method for improving the water transport characteristics of hydrophobic soils. The applicants have found that the application of certain hydrophobic, water insoluble polymers or blends thereof, to hydrophobic soil or turf will improve the ability of water to penetrate the soil surface and infiltrate the treated layers of soil.

This invention is also related to a method of treating turf and soil to alleviate drought stress and soil capping and to improve water conservation in soil. The instant invention further relates to a method of promoting the transport of water through medium and coarse-grained soils.

The present invention is related to capped PEG's, and the use thereof in wetting of soils, wherein the capped PEG comprises a core group, R¹ as will be defined herein, with 2-20 PEG groups extending therefrom wherein the PEG groups have an average of 4-100 —CH₂CH₂O— groups and each PEG group is terminated with a hydrophobe.

Through diligent research it has been surprisingly realized that by changing the terminal hydroxyl groups of the PEG polymer to hydrophobic groups of sufficient size, the wetting agent can be sufficiently anchored to the hydrophobic soil particle surfaces thereby changing the surface to a hydrophilic one. These terminal hydrophobic groups, when chosen properly, continue to anchor the PEG chains so that they resist removal by multiple irrigation or rain events. It is believed that they also slow microbial attack and thus improve their durability in soil. The hydrophobic terminal groups may be connected to the PEG chain through ether, ester, or isocyanate linkages.

The present invention is related poly(ethylene glycol) (PEG) polymers capped on both ends with either ester, ether, or isocyanate groups of sufficient size which, when applied to hydrophobic soils or other plant growth media, the moisture transport and moisture retention properties are greatly enhanced. Plant health is also improved and the incidence of localized dry spot is reduced. These new polymer compositions do not require the incorporation of either random or block groups derived from propylene oxide (PO), also referred to as poly(propylene glycols) (PPG) which is contrary to the expectations in the art.

The capped PEG is generally defined by Formula I:

R¹((CH₂CH₂O)ₙR²)ₓ Formula I

wherein:
R¹ is a core group derived from a linear, cyclic or branched polyol with 1-20 carbons or a linear, cyclic or branched polyamine with 1-20 carbons, and more preferably 5-20 carbons, wherein the hydrogen on the alcohol group or the hydrogens on the amine group are replaced with a PEG; alternatively, R¹ is defined by —R⁶(—C(═O)O—)ₘ;
R² is a hydrophobic group preferably selected from the group consisting of R³, the elements necessary to form an ester, specifically —COR⁴, or the elements necessary to form a urethane, specifically —CONHR⁵;
R³-R⁵ are each independently an alkyl of 6-22 carbons, and more preferably 12-18 carbons, wherein the alkyl is a linear, cyclic or branched and preferably linear;
n, on average, is 4-100 and more preferably 6-30;
x is 2-20, and more preferably 3-8;
R⁶ represents a bond or a linear, cyclic or branched alkyl with 6-22 carbons and more preferably 12-18 carbons; and
m is 2-20, preferably 2-8 and most preferably 2.

The reaction to form embodiments of the invention from polyols is represented by Reaction Scheme 1:

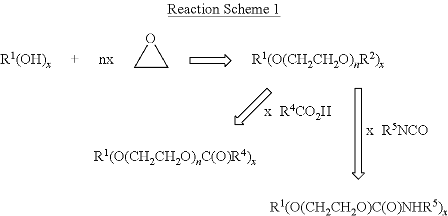

The reaction to form embodiments of the invention from polyamines is represented by Reaction Scheme 2:

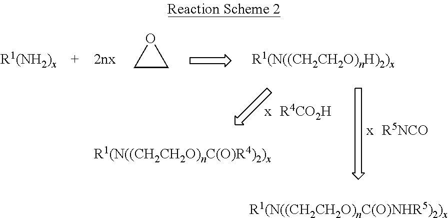

In Reaction Scheme 1 and Reaction Scheme 2, R¹, R³-R⁵, n and x are as defined above. In Formula I and Reaction Schemes 1 and 2 the hydroxyl hydrogens and amine hydrogens are all illustrated as being reacted for convenience with the understanding that some hydroxyl hydrogens and some amine hydrogens may not be reacted due to kinetics, steric hindrances and the like as would be fully understood to those of skill in the art. In an embodiment all hydroxyl hydrogens or amine hydrogens are reacted in accordance with Reaction 1 or Reaction 2.

The core group can comprise a linear, cyclic or branched alkyl, aryl, alkaryl or alkenyl with 1-54 carbons, and more preferably 5-36 carbons, or a diester comprising the group —OC(═O)—R⁶—(C(═O)O—)ₘ₋₁ wherein R⁶ is a bond or a linear, cyclic or branched alkyl with 1-20 carbons. R¹ can comprise, or R⁶ can represent cyclic alkyls of 4-8 carbons.

The longer the EO chain, the better the ability of the polymer when coated onto a hydrophobic surface to draw, or wick, water along the surface and the more water soluble or dispersible it becomes. However, the longer the EO chain, the more readily it may be rinsed off the surface of the soil particle. Therefore, it is preferable that the EO chain length be, on average, 4-100 EO units long, or —CH₂CH₂O— units, long. More preferably 6-30 EO units long

The longer the hydrophobe chain at the ends of the EO chain, the less water soluble or dispersible the capped PEG will be, and the better it will be at anchoring the polymer onto the surface of the soil particle. Thus, balancing the length of the EO chain to improve water movement must be balanced by increasing the length of the hydrophobe chain. Hydrophobes may be alkyls, aryls, alkaryls, alkenyls, or aromatic groups with five or greater carbon atoms. In general, the length of the hydrophobe chain is preferably at least six carbons and preferably not more than 22 carbons long, preferably at least 12 to no more than 18 carbons long.

The number of EO groups and the size of the hydrophobic chain terminating the EO groups are preferably chosen to obtain a hydrophilic/lipophilic balance (HLB) of 7-14.

The PEG chains may be present in the core of the molecule, as may be prepared by ethoxylating either glycerin or trimethylol propane, with 3 branches, or pentaerythritol, with 4 branches, or sorbitol, with 6 branches. The ethoxylated polyol would then be terminated with a hydrophobic group as described elsewhere herein resulting in a capped PEG having the formula:

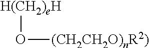

wherein e is 3 for when glycerin is the starting material, e is 4 for pentaerythritol as the starting material and is 6 for sorbitol as the starting material.

A multiply-branched PEG moiety is preferably capped with multiple hydrophobic groups to impart sufficient durability to function well. Preferably, all of the branches are capped with hydrophobic groups so that no uncapped chains remain that may reduce the durability of the coating on the soil particles.

Many of these capped PEG polymers have sufficient water solubility that they may be dispersed into water on their own and still impart a highly durable hydrophilic coating onto a hydrophobic soil particle. However, capped PEG polymers that are not readily dispersible in water may be combined with capped PEG polymers that are dispersible in water so that the combination is dispersible in water. These combinations may have the best resistance to rinsing off the treated soil.

The esterification of the alkoxylated product can be carried out by methods known such as by the use of acidic catalyst. Suitable acidic catalysts for this purpose are, for example, methanesulfonic acid, butanesulfonic acid, p-toluenesulfonic acid, naphthalenesulfonic acid, alkyl benzenesulfonic acid and/or sulfosuccinic acid.

In addition, it is advisable to carry out the esterification reaction at elevated temperatures, for example at temperatures of 140° to 275° C. and preferably 150° to 185° C. and continuously to remove the water of reaction from the equilibrium. The quantity of fatty acid used should be selected so that there are 1.0 to 1.2 and preferably 1.0 to 1.1 moles of fatty acid for every mole of the polyethylene oxide, C₁-C₂₄ alkyl ether alkoxylate. This ensures that the esterification of the hydroxyl groups is substantially quantitative. If desired, a residual content of free fatty acid in the end reaction product may be neutralized with alkali metal hydroxide solution.

The emulsion of the capped PEG polymer of Formula I may then be conveniently applied to the hydrophobic surface or soil by any of a number of methods including dipping, spraying, or wiping the emulsion onto the surface to be treated. After drying to remove the water vehicle, a coating of the inventive polymer remains on the treated surface rendering it hydrophilic. The hydrophilic coating is durable to repeated rinsings with water.

A thin coating of the capped PEG polymer of Formula I on the hydrophobic surfaces or soils is adequate to render it hydrophilic. Application of larger amounts of the polymer of Formula I to a hydrophobic surface to make a thicker coating will not necessarily improve its hydrophilicity.

Amounts of the inventive polymer coating or emulsion necessary for adequate wettability of the hydrophobic surface or soil will vary with the desired level of hydrophilicity and depth of coverage. Moisture movement through treated soils will be improved according to the depth of treatment. Accordingly, the amount of dilution of the polymer of Formula I with water and emulsifiers will best be determined by consideration of the depth of the root zone and the amount of diluted emulsion needed to percolate down to the desired depth. The concentration and volume of the emulsion of the inventive polymer may then be adjusted so that the volume of water and emulsion is sufficient to carry the polymer down to the desired depth to treat the soil particle surfaces.

In general, the polymers of Formula I have low water solubility and some will separate when added to water. These must be emulsified into water for delivery to the hydrophobic soils to be treated via a water spray or other irrigation method. If necessary, the polymers of Formula I may be emulsified in water with any of a number of emulsifiers. Emulsifiers may be chosen to give best stability of the polymer of Formula I in a concentrated form as well as in diluted form for application to hydrophobic surfaces or soils. Preferred emulsifiers include nonionic surfactants, and especially preferred are nonionic ethylene oxide/propylene oxide block copolymers. A surface tension reducing additive may optionally be added to ensure adequate wetting of the hydrophobic surface or soil. Emulsifiers for soil application should be chosen so as not to damage turf or plant life.

Polymers of Formula I can be diluted in water emulsion to 2% active ingredient or less for application to soil or to hydrophobic surfaces. The diluted solution may be applied to soil at a rate sufficient to allow treatment of the soil surface to a depth to encompass the entire turf root zone.

The treated hydrophobic surface becomes rapidly wettable by water, and will cause the treated surface to wick water (cause water to rise vertically up a treated surface). In the case of soils, the ability of water to penetrate soils is greatly increased. Dew formation on treated surfaces such as grass is also prevented.

The compounds of Formula I thus exhibit excellent ability to provide the necessary water adhesion to the hydrophobic surface of the water repellent soil via the hydrophobic groups of the surfactant itself and therefore provide the beneficial wetting characteristics and thus water transport, through the hydrophobic soil. Any adhered water droplets will be pulled into the sand and/or soil by further adhesion by other particles or through cohesion with other water droplets. Thus, such a wetting agent effectively permits appreciable and necessary amounts of moisture to penetrate the topsoil for beneficial moisture supply to the subterranean roots on a consistent and continuous basis for a relatively long period of time.

The compounds of Formula I are useful for improving the water transport characteristics of hydrophobic surfaces.

The invention is also directed to a method for improving the water penetration rate through hydrophobic surfaces, inhibiting the formation of dew on grass, other plant surfaces, or other hydrophobic surfaces by applying an effective amount of a mixture of compounds having the Formula I as defined above. The invention further provides a process for increasing the wetting rate of water repellent soil which comprises the steps of: (i) preparing an aqueous wetting agent composition comprising: (a) a compound of the Formula I (b) optionally a surfactant, and (c) water; and (ii) intimately contacting the water repellent soil with an effective amount of the wetting agent composition.

The instant invention also provides a process for rapidly increasing the hydrophilicity and infiltration of water into water repellent soil matrices. The process consists of applying to the water repellent soil an effective amount of a wetting agent composition comprising a mixture of the Formula I.

The invention also provides a method for improvement and prevention of dry spots on the grass surface of a golf course comprising applying an effective amount of a mixture of the Formula I. An effective amount is that amount sufficient to improve the wetting rate of the hydrophobic soil. An effective amount is typically about 0.5 to about 20 ounces of wetting agent per 1000 ft² of surface. More preferably the effective amount is about 1 to about 10 ounces of wetting agent per 1000 ft² of surface. Even more preferably the effective amount is about 3 to about 7 ounces of wetting agent per 1000 ft² of surface. If the application is below the effective amount dark spots will occur. If the application is above the effective amount no additional benefits are observed and material is wasted which is undesirable.

The compositions of the invention unexpectedly exhibit significantly enhanced infiltration, or wetting, rates in water repellent soil over that previously achieved in the prior art.

The compounds of Formula I are prepared in accordance with Reaction Scheme 1 or 2 by alkoxylation with the required amount of ethylene oxide in the presence of potassium hydroxide at a temperature between 100° C. and 150° C. and more preferably at about 130° C. After the initial reaction, the residual volatiles are removed by stirring under vacuum such as for 30 minutes at 120° C. If required, depending on the degree of ethoxylation one desires, additional ethylene oxide may be optionally added at about 140° C. and allowed to react completely. Residual volatiles would then again be removed by stirring under vacuum such as for 30 minutes at about 120° C. The temperature would then be reduced to about 60° C. and phosphoric acid would be added and stirred for about 30 minutes. The resulting product is typically a viscous clear oil having a molecular weight (MW) in the range of approximately 1200-1800 typically with a hydroxyl number in the range of 40.0-48.0.

The clear oil above is then heated to a temperature between about 80° C. and about 90° C. and then a fatty acid is added in the presence of an acid esterification catalyst. The mixture is heated to about 180°-190° C. with a nitrogen sparge for about 35-40 hours with water distillate being removed. The product ester is then cooled to about 85°-90° C. and then sodium carbonate is added and stirred for about 1 hour. Subsequently, about 50% hydrogen peroxide is added and allowed to stir for about 1 hour. After heating to about 100°-110° C., vacuum is applied and water removed. The resulting mass is cooled to about 50°-60° C. and filtered to remove suspended solids. The product is a viscous clear liquid having the desired acid values, hydroxyl number and saponification value.

After the alkoxylation, the alkoxylated alcohols formed as intermediate products are subjected to esterification. The carboxylic acid component used for this purpose would be selected from linear or branched saturated or unsaturated fatty acids having 1 to 24 carbon atoms. The fatty acid chain may also be substituted with hydroxyl groups.

Typical examples of the fatty acid esterifying agents include lauric acid, myristic acid, palmitic acid, palmitoleic acid, stearic acid, isostearic acid, oleic acid, linoleic acid, linolenic acid, ricinoleic acid, 12-hydroxystearic acid, arachidonic acid, gadoleic acid, behenic acid, dimeric fatty acids, dimeric acids of the above fatty acids and erucic acid. Oleic acid, stearic acid and isostearic acid and technical mixtures thereof are preferred.

As usual in oleochemistry, these acids may also be present in the form of the technical cuts obtained in the pressure hydrolysis of natural fats and oils, for example palm oil, palm kernel oil, coconut oil, olive oil, sunflower oil, rapeseed oil or beef tallow. Fatty acids containing 12 to 18 carbon atoms are preferred, those containing 16 to 18 carbon atoms being particularly preferred.

The instant invention specifically relates to the discovery that wetting agent compositions comprising compounds of the Formula I significantly and unexpectedly enhance water and aqueous composition transport or infiltration through the solid matrices of hydrophobic/water repellent soil, as well as or better than ethylene oxide and propylene oxide copolymers. Additionally, it has been found that these compositions are highly efficacious over a wide range of concentrations which is of critical importance in achieving maximum agronomic and/or hydrological benefit when the compositions are to be used in irrigation scenarios. The benefit is realized in the reduction in run-off and in the delivery of water-soluble fertilizers.

Additionally, the compounds of Formula I of the invention are formulated as an additive for hydrophobic soil for treating sandy areas, soils, or areas including both sand and soil; such as lawns, greens, pastures, beaches, dry desert-like areas, and the like; for effective moisture penetration. The formulations of the invention are also used for reducing localized dry spot formation within lawns or greens by providing long-term wetting treatments comprising the application of a soil additive formulation to a target lawn or green, wherein said soil additive formulation comprises the compounds of Formula I as noted above. The application can be done in a single-application, in a split application spaced 7 to 10 days apart formulations, or in other frequencies as necessary.

The formulations containing the compounds of Formula I and the method of treating sandy areas with such formulations may thus be utilized for the provision of moisture penetration benefits in sandy areas alone. In such a manner, the sandy area, such as a beach, may be modified to permit water penetration therein, to prevent unsightly water pools, for example, after raining, or to dry desert-like areas in order to permit water penetration to sustain root systems of plant-life which would not grow otherwise.

The compounds of Formula I exhibit an excellent ability to provide the necessary water adhesion to the otherwise hydrophobic surface of the water repellent soil via the hydrophobic groups of the surfactant itself and therefore provide the beneficial wetting characteristics and water transport properties through the hydrophobic soil. Any adhered water droplets will be pulled into the sand and/or soil by further adhesion by other particles or through cohesion with other water droplets. The wetting agent effectively permits appreciable and necessary amounts of moisture to penetrate the topsoil for beneficial moisture supply to the subterranean roots on a consistent and continuous basis for a relatively long period of time.

The soil additive formulation may comprise a wetting agent consisting essentially of Formula I or, in an embodiment, the wetting agent may comprise about 0.1-99% by weight compounds of Formula I with additional wetting agents; more preferably the wetting agent comprises about 1-99% by weight Formula I; even more preferably about 5-95% by weight Formula I; more preferably about 10-90% by weight Formula I, with the remainder a mix of other additives as noted below.

In order to best ensure initial penetration of the wetting agents within the target topsoil areas, it is preferable to include at least one secondary compound within the formulation for further lowering of the surface tension at the topsoil surface which is also compatible with the aforementioned wetting agent having Formula I. The lowering of the surface tension allows more rapid penetration of the wetter into the soil profile. Such a secondary compound can be an alkoxylated, preferably ethoxylated alcohol surfactant, such as a branched or unbranched C₆-C₆₀ alcohol ethoxylate or alkoxylated, preferably ethoxylated C₈-C₄₀ fatty acid for utilization in combination with the aforementioned wetting agent of Formula I.

The alkoxylated secondary compounds may be branched or unbranched in configuration. Examples of preferred types of alcohol alkoxylates for this purpose include C₆-C₆₀ alkyl, or alkylaryl EO/PO surfactants, linear or branched, and secondary or primary hydroxyl in type, including mixtures of surfactants comprising from 1 to 95 wt % of at least one surfactant selected from polyalkylene oxide compounds having general Formula II, general Formula III or general Formula IV wherein general Formula III is:

R⁸—O—(C₂H₄O)_{b}(C₃H₆O)_{c}—R⁸ Formula II

wherein b is 0 to 500; c is 0 to 500; and each R⁸ is independently H, or an alkyl group with 1 to 4 carbon atoms; wherein the polyalkylene oxide has a preferred molecular weight in the range of 300 to 51,000; and a second optional different surfactant comprising a compound of general Formula III:

R⁹—O—(CH₂CH₂O)_{z}(CHR¹⁰CH₂O)ₚR¹¹ Formula III

wherein z is from 1 to 50; p is 0-50; R⁹ is a branched or linear alkyl, alkenyl, aryl or an aryl group optionally having an alkyl group substituent, the alkyl group having up to 60 carbon atoms; R¹⁰ is selected from H and alkyl groups having from 1 to 2 carbon atoms; and R¹¹ is selected from H and alkyl groups having from 1 to 30 carbon atoms. Suitable secondary surfactants also include carboxylic and dicarboxylic esters of the general Formula V:

R¹²COₐ(CH₂CH₂O)_{q}(CHR¹³CH₂O)ᵣCO_{d}R¹⁴ Formula IV

wherein q is from 1 to 50; r is 1-50; a is from 1 to 2; d is from 1 to 2; R¹² is an alkyl or alkenyl group having up to 60 carbons or an aryl group optionally having an alkyl group substituent, the alkyl group having up to 60 carbon atoms; R¹³ is selected from H and alkyl groups having from 1 to 2 carbon atoms; and R¹⁴ is selected from H and alkyl groups having from 1 to 30 carbon atoms.

Additional secondary compounds can also be silicone surfactants, alkyl polyglycosides, alkyl sulfonates, alkyleth sulfonates, alkyl sulfosuccinates, or alkaryl sulfonates which are widely known by those skilled in the art to reduce surface tension.

The compounds of Formula I can also prevent development of dry spots on the grass surface of a golf course and also improve and reduce already developed dry spots by sprinkling said compound along with a carrier on the grass surface of a golf course.

### EXAMPLES

### Soil Wettability/Durability Testing

Hydrophobicity of fabric. As a control, a swatch of unfinished woven polypropylene fabric was dipped into isopropyl alcohol (IPA) to remove any surface treatment. The alcohol was subsequently evaporated from the fabric by suspending it in an ambient air flow for 24 hours, leaving nothing on the control. The wettability of the fabric was then tested by gently applying a droplet of water to the surface of the fabric and observing the time required for complete absorption of the droplet. Control 1 confirms that the untreated polypropylene fabric was very hydrophobic and not water-wettable.

TABLE 1

| Example | Control 1 |
|---|---|
| Example 1 product | 0 |
| isopropyl alcohol | 100% |
| Wet pick up | 100% |
| Amount surfactant deposited | 0% |
| Time to absorbance of water droplet | no absorption within 10 minutes |

Wettability of hydrophobic fabric—Application of surfactants to impart hydrophilicity to a hydrophobic surface. A solution of 2.0% of surfactant(s) and either A) 98% demineralized water (DMW) or B) 1:1 DMW:anhydrous isopropyl alcohol (IPA) was prepared. The solution was applied to a finish-free polypropylene fabric by a dip method so that the wet-pick-up of the fabric was 100%. The diluent was subsequently evaporated from the fabric by suspending it in an oven for until dry, leaving 2% by weight of the surfactant(s) on the test fabric. The wettability of the fabric was then tested by gently applying a droplet of water to the surface of the fabric and observing the time required for complete absorption of the droplet.

Durability of hydrophilic treatment. After measuring the 2% treated fabric swatch for wettability, the swatch was immersed fully in ambient tap water and then dried in an oven. After removing from the oven and cooling, the wettability of the fabric was then tested by gently applying a droplet of water to the surface of the fabric and observing the time required for complete absorption of the droplet. This cycle of rinsing, drying, and retesting was repeated generating samples which were tested for up to 5 rinses or >60 seconds for full absorption time, whichever happened first.

### Results of Soil Wettability and Durability Testing

Examples tested are in Table 2. Examples were tested in 2% DMW for soil wetting and durability with results reported in seconds with <1 indicating less than 1 second and more than 60 seconds indicated by >60 in Tables 3-5.

TABLE 2

| | Noted on Tables |
|---|---|
| Example | 3-5 as |
| Blend of EO/PO block copolymers, dioleate and | STD PO1 |
| sodium dioctyl sulfosuccinate | |
| difunctional EO/PO block copolymer, 80% PO | STD PO2 |
| reverse block copolymer, 74% PO, 26% EO | STD PO3 |
| POE (50) Sorbitol hexaoleate | F1-1 |
| PEG 600 dioleate | F1-2 |
| POE (50) Sorbitol oleic coconut mixed fatty acid | F1-3 |
| ester | |
| 1:3 blend of POE (26) Castor oil trilaurate:PEG 600 | F1-4 |
| Dioleate | |
| 1:1 blend of POE (26) Castor oil trilaurate:PEG 600 | F1-5 |
| Dioleate | |
| 3:1 blend of POE (26) Castor oil trilaurate:PEG 600 | F1-6 |
| Dioleate | |
| PEG 6000 distearate | F1-7 |
| PEG 400 distearate | F1-8 |
| POE (150) Pentaerythritol tetrastearate | F1-9 |
| POE (26) Glycerin mono-oleate | F1-10 |
| POE (26) Glycerin dioleate | F1-11 |
| POE (26) Glycerin trioleate | F1-12 |
| POE (26) Glycerin dicocoate | F1-13 |
| POE (26) Glycerin tricocoate | F1-14 |
| POE (12) lauryl alcohol dimer acid diester | F1-15 |
| POE (23) lauryl alcohol dimer acid diester | F1-16 |
| POE (30) Pentaerythritol tetrastearate | F1-17 |
| POE (37) Ethylene diamine tetraoleate | F1-18 |
| POE (37) Ethylene diamine tetraoleate | F1-19 |
| Blend of POE (26) Glycerin hydroxystearic acid | F1-20 |
| ester, PEG 600 dioleate, and sodium dioctyl | |
| sulfosuccinate | |
| POE (12) lauryl alcohol adipic acid diester | F1-21 |
| POE (23) lauryl alcohol adipic acid diester | F1-22 |
| POE (12) lauryl alcohol terephthalic acid ester | F1-23 |

TABLE 3

| | STD | STD | STD | | | | | | |
|---|---|---|---|---|---|---|---|---|---|
| | PO 1¹ | PO 2¹ | PO 3¹ | F1-1¹ | F1-2¹ | F1-3¹ | F1-4¹ | F1-5¹ | F1-6¹ |
| Initial | <1 | <1 | <1 | <1 | <1 | 1.84 | <1 | <1 | <1 |
| 1 rinse | <1 | 1.99 | 1.97 | <1 | <1 | 2.10 | <1 | <1 | <1 |
| 2 rinse | 1.09 | >60 | >60 | <1 | 1.29 | >60 | 2.36 | 1.08 | <1 |
| 3 rinses | 1.22 | | | <1 | 5.67 | | 7.68 | 1.41 | <1 |
| 4 rinses | 1.52 | | | 3.51 | >60 | | >60 | 2.1 | <1 |
| 5 rinses | 1.77 | | | 6.05 | | | | 12.21 | 1.42 |

¹in DMW

TABLE 4

| | F1-7¹ | F1-8¹ | F1-9¹ | F1-10¹ | F1-11¹ | F1-12² | F1-13¹ | F1-14² | F1-15¹ |
|---|---|---|---|---|---|---|---|---|---|
| Initial | >60 | 4.40 | 6.59 | 12.63 | 5.99 | 3.27 | 2.06 | 1.71 | 2.60 |
| 1 rinse | | 6.58 | 19.28 | >60 | >60 | 3.52 | 20.31 | 2.50 | 4.58 |
| 2 rinse | | 6.53 | 29.25 | | | 3.72 | >60 | 3.46 | 8.67 |
| 3 rinses | | 7.78 | | | | 2.63 | | 14.21 | 19.65 |
| 4 rinses | | 8.33 | | | | 2.67 | | 14.93 | 29.69 |
| 5 rinses | | 9.69 | | | | 2.47 | | >60 | 32.97 |

¹in DMW
²in 1:1 DMW:IPA

TABLE 5

| | F1-16² | F1-17¹ | F1-18¹ | F1-19² | F1-20¹ | F1-21¹ | F1-22¹ | F1-23¹ |
|---|---|---|---|---|---|---|---|---|
| Initial | 12.39 | <1 | 3.46 | 2.20 | 3.74 | 1.91 | 12.68 | <1 |
| 1 rinse | 43.25 | <1 | 4.05 | 2.57 | 4.00 | 3.00 | 17.11 | <1 |
| 2 rinse | >60 | 1.03 | 5.25 | 3.14 | 5.63 | 2.44 | 53.26 | 1.05 |
| 3 rinses | | 4.03 | 5.71 | 2.91 | 20.33 | 1.59 | >60 | 2.41 |
| 4 rinses | | >60 | 4.85 | 3.06 | >60 | 1.31 | | 27.32 |
| 5 rinses | | | 3.01 | 2.93 | | 1.35 | | >60 |

¹in DMW
²in 1:1 DMW:IPA

Test data presented in Table 1 and Tables 3-5 is time in seconds for a water droplet placed on a cloth sample to wick into the sample. The rate at which the water droplet wicks into the sample is representative of the ability of the water droplet to wet hydrophobic soil after treatment with shorter times being preferred. PO-containing wetting agents were used as standards for comparison. Soil wettability is determined in the initial reading. Durability is determined through multiple rinse cycles.

Not all results are presented for all samples.

The invention has been described with reference to preferred embodiments without limit thereto. One of skill in the art would realize additional embodiments which are described and set forth in the claims appended hereto.

1. A mixture for treating a hydrophobic surface comprising:
a wetting agent comprising;
a compound of Formula I:
R¹((CH₂CH₂O)ₙR²)ₓ Formula I
wherein:
R¹ is a core group derived from a linear, cyclic or branched polyol with 1-55 carbons or a linear, cyclic or branched polyamine with 1-22 carbons wherein hydrogens on the alcohol group or hydrogens on the amine group are replaced with (CH₂CH₂O)ₙ or R¹ is defined by —R⁶(—C(═O)O—)ₘ;
R² is a hydrophobic group preferably selected from the group consisting of R³, the elements necessary to form an ester, specifically —COR⁴, or the elements necessary to form a urethane, specifically —CONHR⁵;
R³-R⁵ are each independently an alkyl of 6-22 carbons, wherein the alkyl is a linear, cyclic or branched and preferably linear;
n, on average is 4-100;
x is 2-20;
R⁶ represents a bond or a linear, cyclic or branched alkyl with 6-22 carbons; and
m is 2-20.

2. The mixture for treating a hydrophobic surface of claim 1 wherein each said hydrogens on said alcohol group or each said hydrogen on said amine group are replaced with (CH₂CH₂O)ₙ.

3. The mixture for treating a hydrophobic surface of claim 1 wherein said Formula I is defined by: 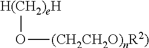
wherein e is 3-6.

4. The mixture for treating a hydrophobic surface of claim 1 wherein said R¹ comprises 5-20 carbons.

5. The mixture for treating a hydrophobic surface of claim 1 wherein said R³-R⁵ are each independently an alkyl of 12-18 carbons.

6. The mixture for treating a hydrophobic surface of claim 1 wherein n on average is 6-30.

7. The mixture for treating a hydrophobic surface of claim 1 wherein x is 3-8.

8. The mixture for treating a hydrophobic surface of claim 1 wherein R⁶ has 12-18 carbons.

9. The mixture for treating a hydrophobic surface of claim 1 wherein said m is 2-8.

10. The mixture for treating a hydrophobic surface of claim 9 wherein said m is 2.

11. The mixture for treating a hydrophobic surface of claim 1 wherein said Formula I has an HLB 7-14.

12. The mixture for treating a hydrophobic surface of claim 1 wherein said compound of Formula I has a molecular weight of 1200-1800.

13. The mixture for treating a hydrophobic surface of claim 1 wherein said compound of Formula I has a hydroxyl number of 40.0-48.0.

14. The mixture for treating a hydrophobic surface of claim 1 wherein said wetting agent further comprising a compound defined by Formula II:
R⁸—O—(C₂H₄O)_{b}(C₃H₆O)_{c}—R⁸ Formula II
wherein:
b is 0 to 500;
c is 0 to 500; and
each R⁸ is independently H, or an alkyl group with 1 to 4 carbon atoms.

15. The mixture for treating a hydrophobic surface of claim 14 wherein said wetting agent comprises 1-95 wt % said Formula II.

16. The mixture for treating a hydrophobic surface of claim 14 wherein said compound defined by Formula II has a molecular weight of 300 to 51,000.

17. The mixture for treating a hydrophobic surface of claim 1 wherein said wetting agent further comprising a compound defined by Formula III:
R⁹—O—(CH₂CH₂O)_{z}(CHR¹⁰CH₂O)ₚR¹¹ Formula III
wherein:
z is from 1 to 50;
p is 0-50;
R⁹ is a branched or linear alkyl, alkenyl, aryl or an aryl group optionally having an alkyl group substituent, the alkyl group having up to 60 carbon atoms;
R¹⁰ is selected from H and alkyl groups having from 1 to 2 carbon atoms; and
R¹¹ is selected from H and alkyl groups having from 1 to 30 carbon atoms.

18. The mixture for treating a hydrophobic surface of claim 17 wherein said wetting agent comprises 1-95 wt % said Formula III.

19. The mixture for treating a hydrophobic surface of claim 1 wherein said wetting agent further comprising a compound defined by Formula IV:
R¹²COₐ(CH₂CH₂O)_{q}(CHR¹³CH₂O)ᵣCO_{d}R¹⁴ Formula IV
wherein:
q is from 1 to 50;
r is 1-50;
a is from 1 to 2;
d is from 1 to 2;
R¹² is an alkyl or alkenyl group having up to 60 carbons or an aryl group optionally having an alkyl group substituent, the alkyl group having up to 60 carbon atoms;
R¹³ is selected from H and alkyl groups having from 1 to 2 carbon atoms; and
R¹⁴ is selected from H and alkyl groups having from 1 to 30 carbon atoms.

20. The mixture for treating a hydrophobic surface of claim 19 wherein said wetting agent comprises 1-95 wt % said Formula IV.

21. The mixture for treating a hydrophobic surface of claim 1 further comprising a surfactant.

22. The mixture for treating a hydrophobic surface of claim 21 further wherein said surfactant is a silicone surfactant.

23. The mixture for treating a hydrophobic surface of claim 1 wherein said hydrophobic surface comprises soil.

24. The mixture for treating a hydrophobic surface of claim 1 further comprising water.

25. A method for treating a hydrophobic surface comprising:
forming a wetting agent comprising;
a compound of Formula I:
R¹((CH₂CH₂O)ₙR²)ₓ Formula I
wherein:
R¹ is a core group derived from a linear, cyclic or branched polyol with 1-20 carbons or a linear, cyclic or branched polyamine with 1-20 carbons wherein hydrogens on the alcohol group or hydrogens on the amine group are replaced with (CH₂CH₂O)ₙ or R¹ is defined by —R⁶(—C(═O)O—)ₘ;
R² is a hydrophobic group preferable selected from the group consisting of R³, the elements necessary to form an ester, specifically —COR⁴, or the elements necessary to form a urethane, specifically —CONHR⁵;
R³-R⁵ are each independently an alkyl of 6-22 carbons, wherein the alkyl is a linear, cyclic or branched and preferably linear;
n, on average is 4-100;
x is 2-20;
R⁶ represents a bond or a linear, cyclic or branched alkyl with 6-22 carbons; and
m is 2-20;
and applying said wetting agent to said hydrophobic surface.

26. The method for treating a hydrophobic surface of claim 25 wherein each said hydrogens on said alcohol group or each said hydrogen on said amine group are replaced with (CH₂CH₂O)ₙ.

27. The method for treating a hydrophobic surface of claim 25 wherein said Formula I is defined by: 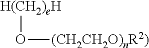
wherein e is 3-6.

28. The method for treating a hydrophobic surface of claim 25 wherein said R¹ comprises 5-55 carbons.

29. The method for treating a hydrophobic surface of claim 25 wherein said R³-R⁵ are each independently an alkyl of 12-18 carbons.

30. The method for treating a hydrophobic surface of claim 25 wherein n on average is 6-30.

31. The method for treating a hydrophobic surface of claim 25 wherein x is 3-8.

32. The method for treating a hydrophobic surface of claim 25 wherein R⁶ has 12-18 carbons.

33. The method for treating a hydrophobic surface of claim 25 wherein said m is 2-8.

34. The method for treating a hydrophobic surface of claim 25 wherein said m is 2.

35. The method for treating a hydrophobic surface of claim 25 wherein said Formula I has an HLB 7-14.

36. The method for treating a hydrophobic surface of claim 25 wherein said applying is selected from the group consisting of dipping, spraying and wiping.

37. The method for treating a hydrophobic surface of claim 25 wherein said applying is done in a single-application or in multiple applications.

38. The method for treating a hydrophobic surface of claim 37 wherein said multiple applications are 7 to 10 days apart.

39. The method for treating a hydrophobic surface of claim 25 wherein said compound of Formula I has a molecular weight of 1200-1800.

40. The method for treating a hydrophobic surface of claim 25 wherein said compound of Formula I has a hydroxyl number of 40.0-48.0.

41. The method for treating a hydrophobic surface of claim 35 wherein said wetting agent further comprising a compound defined by Formula II:
R⁸—O—(C₂H₄O)_{b}(C₃H₆O)_{c}—R⁸ Formula II
wherein:
b is 0 to 500;
c is 0 to 500; and
each R⁸ is independently H, or an alkyl group with 1 to 4 carbon atoms.

42. The method for treating a hydrophobic surface of claim 41 wherein said wetting agent comprises 1-95 wt % said Formula II.

43. The method for treating a hydrophobic surface of claim 41 wherein said compound defined by Formula II has a molecular weight of 300 to 51,000.

44. The method for treating a hydrophobic surface of claim 25 wherein said wetting agent further comprising a compound defined by Formula III:
R⁹—O—(CH₂CH₂O)_{z}(CHR¹⁰CH₂O)ₚR¹¹ Formula III
wherein:
z is from 1 to 50;
p is 0-50;
R⁹ is a branched or linear alkyl, alkenyl, aryl or an aryl group optionally having an alkyl group substituent, the alkyl group having up to 60 carbon atoms;
R¹⁰ is selected from H and alkyl groups having from 1 to 2 carbon atoms; and
R¹¹ is selected from H and alkyl groups having from 1 to 30 carbon atoms.

45. The method for treating a hydrophobic surface of claim 44 wherein said wetting agent comprises 1-95 wt % said Formula III.

46. The method for treating a hydrophobic surface of claim 25 wherein said wetting agent further comprising a compound defined by Formula IV:
R¹²COₐ(CH₂CH₂O)_{q}(CHR¹³CH₂O)ᵣCO_{d}R¹⁴ Formula IV
wherein:
q is from 1 to 50;
6 is 1-50;
a is from 1 to 2;
d is from 1 to 2;
R¹² is an alkyl or alkenyl group having up to 60 carbons or an aryl group optionally having an alkyl group substituent, the alkyl group having up to 60 carbon atoms;
R¹³ is selected from H and alkyl groups having from 1 to 2 carbon atoms; and
R¹⁴ is selected from H and alkyl groups having from 1 to 30 carbon atoms.

47. The method for treating a hydrophobic surface of claim 46 wherein said wetting agent comprises 1-95 wt % said Formula IV.

48. The method for treating a hydrophobic surface of claim 25 further comprising a surfactant.

49. The method for treating a hydrophobic surface of claim 48 further wherein said surfactant is a silicone surfactant.

50. The method for treating a hydrophobic surface of claim 25 wherein said hydrophobic surface comprises soil.

51. The method for treating a hydrophobic surface of claim 25 further comprising water.
